(19) United States
(12) Patent Application Publication
(10) Pub. No.: US 2025/0385268 A1
(43) Pub. Date: Dec. 18, 2025

(54) POSITIVE ELECTRODE CURRENT COLLECTOR FOR LITHIUM SECONDARY BATTERY, PREPARATION METHOD THEREFOR, AND LITHIUM SECONDARY BATTERY COMPRISING SAME

(71) Applicant: SK ON CO., LTD., Seoul (KR)

(72) Inventors: Chang Mook HWANG, Daejeon (KR); Hyun Ji KIM, Daejeon (KR); Jong Hyeok LEE, Daejeon (KR); Yoon Ji JO, Daejeon (KR)

(21) Appl. No.: 19/125,743

(22) PCT Filed: Jun. 1, 2023
(86) PCT No.: PCT/KR2023/007500

§ 371 Date: Apr. 30, 2025

(30) Foreign Application Priority Data
Oct. 31, 2022 (KR) 10-2022-0143040

(51) Int. Cl. H01M 4/66; H01M 4/04; H01M 10/052

(52) U.S. Cl. CPC H01M 4/667; H01M 4/0435; H01M 4/0471; H01M 4/661; H01M 10/052

(57) ABSTRACT

A cathode current collector for a lithium secondary battery according to embodiments of the present invention may include a first metal layer which includes a first region and a second region having a thickness smaller than that of the first region, and a second metal layer disposed on the second region of the first metal layer and having a different composition from the first metal layer. Accordingly, when the cathode current collector is coupled with a cathode tab, etc., heat generation due to a difference in resistance at the coupled portion may be prevented.

### TECHNICAL FIELD

The present disclosure relates to a positive electrode (“cathode”) current collector for a lithium secondary battery, a method of preparing the cathode current collector for a lithium secondary battery, and a lithium secondary battery including the cathode current collector for a lithium secondary battery.

### BACKGROUND ART

A secondary battery is a battery that can be repeatedly charged and discharged. With rapid progress of information and communication technology and display industries, the secondary battery has been widely applied to various portable electronic telecommunication devices such as a camcorder, a mobile phone, a laptop computer, etc. as their power sources. Recently, a battery pack including the secondary battery has also been developed and applied to eco-friendly automobiles such as an electric vehicle, a hybrid vehicle, etc., as their power sources.

Examples of the secondary battery may include a lithium secondary battery, a nickel-cadmium battery, a nickel-hydrogen battery and the like. Among them, the lithium secondary battery has a high operating voltage and a high energy density per unit weight, making it advantageous in terms of charging speed and lightweight design. In this regard, the lithium secondary battery has been actively developed and applied to various industrial fields.

For example, the lithium secondary battery may include: an electrode assembly including a cathode, an anode, and a separation membrane (separator); and an electrolyte in which the electrode assembly is impregnated. The lithium secondary battery may further include, for example, a pouch-type outer case in which the electrode assembly and the electrolyte are housed.

In the lithium secondary battery, the cathode may be formed by applying a cathode active material to a cathode current collector, followed by drying and pressing the same. The cathode current collector may be connected to a cathode tab and may protrude from the outer case.

However, when the cathode current collector is coupled with the cathode tab, a resistance difference occurs due to a difference in composition between the cathode current collector and the cathode tab, and excessive heat may be generated at the bonding portion of the cathode current collector and the cathode tab.

For example, Korean Patent Registration No. 10-2283842 discloses an electrode current collector for a lithium secondary battery including a novel conductive material.

### SUMMARY OF INVENTION

### Problems to be Solved by Invention

An object of the present disclosure is to provide a cathode current collector for a lithium secondary battery with improved stability.

Another object of the present disclosure is to provide a method of preparing the cathode current collector for a lithium secondary battery.

In addition, another object of the present disclosure is to provide a lithium secondary battery including the cathode current collector for a lithium secondary battery.

### Means for Solving Problems

A cathode current collector for a lithium secondary battery according to exemplary embodiments may include: a first metal layer which includes a first region and a second region having a thickness smaller than that of the first region; and a second metal layer which is disposed on the second region of the first metal layer and has a different composition from that of the first metal layer.

In some embodiments, the first metal layer may be a single layer containing aluminum.

In some embodiments, the second metal layer may include copper.

In some embodiments, the second metal layer may include an aluminum-copper alloy layer disposed on the second region of the first metal layer, and a copper layer disposed on the aluminum-copper alloy layer.

In some embodiments, the aluminum-copper alloy layer may include at least one of Al₂Cu, AlCu and AlCu₂.

In some embodiments, the second metal layer may be not formed on the first region of the first metal layer.

In some embodiments, the cathode current collector may have a constant thickness overall.

In some embodiments, the second region may include a distal part having a constant thickness, and an inclined part extending between the first region and the distal part, wherein the thickness of the inclined part may gradually decrease toward the distal part from the first region.

In some embodiments, the second metal layer may be formed on both surfaces of the second region of the first metal layer.

A lithium secondary battery according to exemplary embodiments may include: a cathode which includes the above-described cathode current collector, and a cathode active material layer disposed on the cathode current collector; and an anode disposed to face the cathode.

In some embodiments the cathode current collector may include an active region corresponding to the first region, and a bonding region corresponding to the second region, and the cathode active material layer may be disposed on at least a portion of the active region.

A method of preparing a cathode current collector for a lithium secondary battery according to exemplary embodiments may include: forming a preliminary current collector by bonding a second metal foil different from the first metal foil on a partial region of at least one surface of the first metal foil; and heat treating the preliminary current collector, wherein the preliminary current collector includes a first preliminary metal layer which includes an active part and a non-coated part having a thickness smaller than that of the active part, and a second preliminary metal layer formed on the non-coated part.

In some embodiments, the step of forming a preliminary current collector may include: pressing a partial region of the first metal foil to form a groove; and bonding the second metal foil to the groove.

In some embodiments, the step of forming a preliminary current collector may include: placing the second metal foil on a partial region of the first metal foil; and rolling and bonding the first metal foil and the second metal foil.

In some embodiments, the preliminary current collector may further include a preliminary alloy layer formed between the first preliminary metal layer and the second preliminary metal layer.

In some embodiments, the step of forming a preliminary current collector may further include: hot rolling the first metal foil to which the second metal foil is bonded.

In some embodiments, the step of heat treating the preliminary current collector may include: cold rolling the preliminary current collector; and annealing the cold rolled preliminary current collector.

In some embodiments, the second metal foil may be bonded to a central portion in a width direction of the first metal foil along a longitudinal direction, and the method may further include, after the step of heat treating the preliminary current collector, slitting the central portion in the width direction of the heat treated preliminary current collector along the longitudinal direction.

### Advantageous Effects

The cathode current collector for a lithium secondary battery according to exemplary embodiments may include two or more metal layers having different compositions in a partial region. The region where the two or more metal layers are formed may be used as a bonding region with a cathode tab. Accordingly, when the cathode tab is bonded to the cathode current collector, a homogeneous bond may be implemented at the bonding portion, thereby suppressing heat generation due to a resistance difference.

In some embodiments, the lithium secondary battery may include the cathode current collector. Accordingly, the internal resistance of the secondary battery may be reduced, and the capacity characteristics may be improved.

### BRIEF DESCRIPTION OF DRAWINGS

FIG. 1 is a schematic cross-sectional view illustrating a cathode current collector for a lithium secondary battery according to exemplary embodiments.

FIG. 2 is a schematic flowchart for describing a method of preparing a cathode current collector for a lithium secondary battery according to exemplary embodiments.

FIG. 3 is a schematic cross-sectional view illustrating a cathode for a lithium secondary battery according to exemplary embodiments.

FIGS. 4 and 5 are a schematic plan view and a cross-sectional view illustrating a lithium secondary battery according to exemplary embodiments.

### MODE FOR CARRYING OUT INVENTION

Embodiments of the present invention provide a cathode current collector for a lithium secondary battery including two or more metal layers in a partial region, and a method of preparing the same. In addition, a lithium secondary battery including the cathode current collector for a lithium secondary battery is also provided.

Hereinafter, the embodiments of the present invention will be described in detail with reference to the accompanying drawings. However, since the drawings attached to the present disclosure are only given for illustrating one of several preferred embodiments of present invention to easily understand the technical spirit of the present invention with the above-described invention, it should not be construed as limited to such a description illustrated in the drawings.

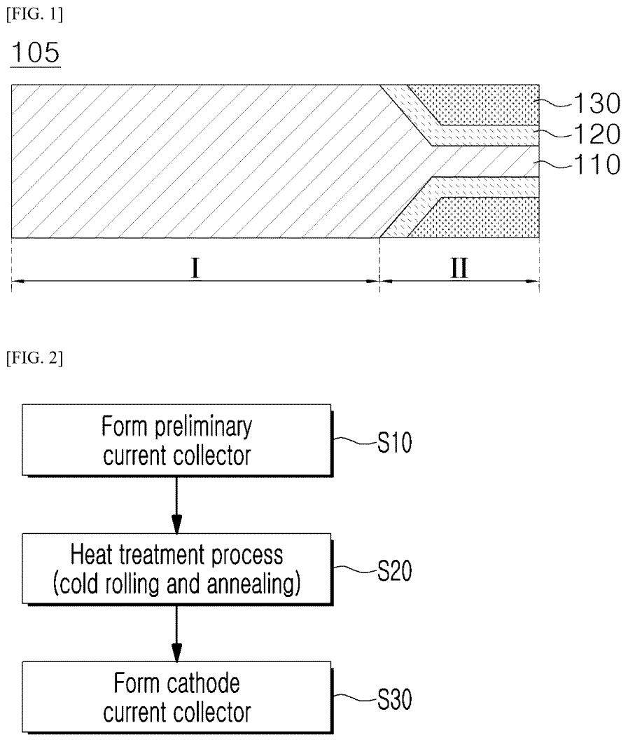

FIG. 1 is a schematic cross-sectional view illustrating a cathode current collector for a lithium secondary battery according to exemplary embodiments.

Referring to FIG. 1, a cathode current collector 105 according to an embodiment may include a first metal layer 110 and a second metal layer 130. For example, the first metal layer 110 may include a first metal. For example, the second metal layer 130 may include a second metal having a different composition from that of the first metal.

In exemplary embodiments, the first metal layer 110 may include a first region I and a second region II having a thickness smaller than that of the first region I, and the second metal layer 130 may be disposed on the second region II of the first metal layer 110. In this case, the second metal layer 130 may not be disposed on the first region I.

In some embodiments, the first region I of the first metal layer 110 may correspond to an active region of the cathode current collector 105. The active region may be a region where a cathode active material layer 140 is formed.

In some embodiments, the second region II of the first metal layer 110 may correspond to a bonding region of the cathode current collector 105. The bonding region may be a region where the cathode current collector is bonded to the cathode tab.

In some embodiments, a density in the second region II of the first metal layer 110 may be different from a density in the first region I. For example, since the second metal layer 130 having a different composition from that of the first metal layer 110 is formed on the second region II, the second region II may have a different density from the first region I.

For example, the density in the second region II of the first metal layer 110 may be greater than the density in the first region I. For example, the density in the second region II of the first metal layer 110 may be smaller than the density in the first region I.

In some embodiments, the thickness of the second metal layer 130 may be substantially equal to half the difference between the thickness of the first metal layer 110 in the first region I and the thickness of the second region II.

In one embodiment, a sum of the thicknesses of the first metal layer 110 and the second metal layer 130 in the second region II may be substantially equal to the thickness of the first metal layer 110 in the first region I.

Accordingly, the cathode current collector 105 may have a constant thickness overall. Since the thickness of the cathode current collector 105 is constant over the entire region of the cathode current collector 105, for example, the coating property of the cathode active material may be improved, and the thickness and volume may be reduced during stacking of the electrode assembly.

In some embodiments, the second region II may include a distal part having a constant thickness and an inclined part extending between the first region I and the distal part. Accordingly, a bonding area between the first metal layer 110 and the second metal layer 130 may be expanded during bonding thereof, thereby improving the bonding strength of the first metal layer 110 and the second metal layer 130. As a result, it is possible to prevent the separation or peeling between the first metal layer 110 and the second metal layer 130.

In one embodiment, the thickness of the inclined part may gradually decrease toward the distal part from the first region I. Accordingly, when the second metal layer 130 is rolled and bonded to the first metal layer 110, a uniform rolling strength may be applied, thereby suppressing non-uniformity in the bonding strength.

In some embodiments, the second metal layers 130 may be disposed on both surfaces of the second region II of the first metal layer 110. Accordingly, when the cathode current collector 105 is bonded to the cathode tab, a resistance change at the bonding portion between the cathode current collector 105 and the cathode tab may be uniform throughout the bonding portion.

In some embodiments, the compositions of the first metal layer 110 and the second metal layer 130 may be different.

For example, the first metal layer 110 may be a single layer containing aluminum, and the second metal layer 130 may be a metal layer containing copper. In addition, for example, the first metal layer 110 may be a single layer containing copper, and the second metal layer 130 may be a metal layer containing aluminum.

In some embodiments, an alloy layer 120 may be formed between the first metal layer 110 and the second metal layer 130 in the second region II. For example, the alloy forming the alloy layer 120 may be an alloy of the first metal used to form the first metal layer 110 and the second metal used to form the second metal layer 130.

Accordingly, the alloy layer 120 may serve as a buffer layer for the change in composition between the first metal layer 110 and the second metal layer 130, and may prevent the separation between the first metal layer 110 and the second metal layer 130.

In one embodiment, the alloy layer 120 may be an aluminum-copper alloy layer. The aluminum-copper alloy layer may include, for example, at least one of Al₂Cu, AlCu and AlCu₂.

As described above, when the first metal layer 110 is an aluminum layer and the second metal layer 130 is a copper layer, the cathode current collector 105 may include a stacked structure including an aluminum layer, an aluminum-copper alloy layer formed on the aluminum layer, and a copper layer formed on the aluminum-copper alloy layer in the bonding region.

When the first metal layer 110 is a copper layer and the second metal layer 130 is an aluminum layer, the cathode current collector 105 may include a stacked structure including a copper layer, an aluminum-copper alloy layer formed on the copper layer, and an aluminum layer formed on the aluminum-copper alloy layer in the bonding region.

FIG. 2 is a schematic flowchart for describing a method of preparing a cathode current collector for a lithium secondary battery according to exemplary embodiments.

Referring to FIG. 2, a preliminary current collector may be formed from a first metal foil and a second metal foil (e.g., process S10).

According to exemplary embodiments, the preliminary current collector may be formed by bonding the second metal foil to a partial region of at least one surface of the first metal foil.

The first metal foil and the second metal foil may have different compositions. For example, the first metal foil may be an aluminum foil, and the second metal foil may be a copper foil. For example, the first metal foil may be a copper foil, and the second metal foil may be an aluminum foil.

In some embodiments, the first metal foil and the second metal foil may be bonded using a roll-to-roll process.

In one embodiment, a partial region of the first metal foil may be pressed to form a groove, and the second metal foil may be bonded to the groove to form the preliminary current collector. Accordingly, the bonding position of the second metal foil on the first metal foil may be selectively determined in advance, thereby improving the bonding positional precision.

In one embodiment, the second metal foil may be placed on a partial region of the first metal foil, and the first metal foil and the second metal foil may be rolled and bonded to form the preliminary current collector.

In this case, the second metal foil may be rolled onto the first metal foil so that the thickness of the preliminary current collector may be constant overall. Accordingly, the first metal foil and the second metal foil may be bonded through a single roll pressing, thereby improving the processing speed.

In some embodiments, the region where the second metal foil is bonded may be an end portion of the first metal foil.

In some embodiments, the region where the second metal foil is bonded may correspond to a central portion in the width direction of the first metal foil. Accordingly, the second metal foil may be bonded to the central portion in the width direction of the first metal foil along the longitudinal direction. The term “longitudinal direction” as used herein may refer to a direction perpendicular to the width direction.

In some embodiments, the preliminary current collector may include a first preliminary metal layer including an active part and a non-coated part having a thickness smaller than that of the active part, and a second preliminary metal layer formed on the non-coated part of the first preliminary metal layer.

The first region I of the first metal layer may be formed from the active part, and may correspond to the active region of the cathode current collector 105, on which the cathode active material layer 140 is formed. Accordingly, the cathode active material layer 140 may be formed on a single metal layer.

The second region II of the first metal layer may be formed from the non-coated part, and may correspond to a bonding region where the cathode current collector 105 is bonded to the cathode tab. Accordingly, the composition of the non-coated part may be adjusted so that the cathode current collector 105 may be homogeneously bonded to the cathode tab.

In one embodiment, the preliminary current collector may further include a preliminary alloy layer formed between the first preliminary metal layer and the second preliminary metal layer. For example, the preliminary alloy layer may be formed of an alloy of the first metal used to form the first preliminary metal layer and the second metal used to form the second preliminary metal layer.

In some embodiments, the preliminary current collector may be formed by bonding the second metal foil to the first metal foil, and then hot rolling the first metal foil to which the second metal foil is bonded. Accordingly, the alloy forming the preliminary alloy layer between the first preliminary metal layer and the second preliminary metal layer may be recrystallized, thereby eliminating segregation of the preliminary alloy layer.

In some embodiments, the first metal used to form the first preliminary metal layer may be aluminum, and the second metal used to form the second preliminary metal layer may be copper.

In this case, the non-coated part of the preliminary current collector may include an aluminum layer, an aluminum-copper alloy layer formed on the aluminum layer, and a copper layer formed on the aluminum-copper alloy layer. Accordingly, even when the cathode tab is formed of copper, homogeneous bonding with the cathode current collector 105 formed from the preliminary current collector may be implemented. Therefore, it is possible to suppress heat generation by preventing resistance differences caused by bonding between heterogeneous metals.

In some embodiments, the first metal used to form the first preliminary metal layer may be copper, and the second metal used to form the second preliminary metal layer may be aluminum.

In this case, the non-coated part of the preliminary current collector may include a copper layer, an aluminum-copper alloy layer formed on the copper layer, the aluminum layer and an aluminum layer formed on the aluminum-copper alloy layer. In addition, the active part may be a copper layer. Accordingly, the electrical conductivity of the cathode current collector 105 formed from the preliminary current collector may be improved, thereby enhancing the energy density of the lithium secondary battery.

According to exemplary embodiments, the preliminary current collector may be heat treated to prepare the cathode current collector 105 (e.g., processes S20 and S30).

In some embodiments, the preliminary current collector may be cold rolled, and the cold rolled preliminary current collector may be annealed to heat treat the preliminary current collector.

In one embodiment, the preliminary current collector may be cold rolled to reduce the thickness of the preliminary current collector. Accordingly, the mechanical strength and hardness of the preliminary current collector may be improved.

In one embodiment, the cold rolled preliminary current collector may be annealed to remove internal stress of the cold rolled preliminary current collector and soften it.

In one embodiment, the cold rolling and the annealing may be repeatedly performed. Accordingly, the mechanical strength of the preliminary current collector may be improved and metal crystals may be refined.

In some embodiments, as described above, the second metal foil may be bonded to the central portion in the width direction of the first metal foil. In this case, after the heat treatment step, the central portion of the heat treated preliminary current collector in the width direction may be slit along the longitudinal direction to prepare the current collector. Accordingly, a plurality of current collectors may be formed by a single process, thereby improving the production yield of the cathode current collector 105.

In some embodiments, both corners of the non-coated part of the cathode current collector 105 may be subjected to notching.

In one embodiment, the width of the non-coated part of the cathode current collector 105 including the non-coated part, in which the corners are notched, may be the same as the width of the cathode tab. Accordingly, when the non-coated part and the cathode tab are bonded, electrical conductivity may be improved.

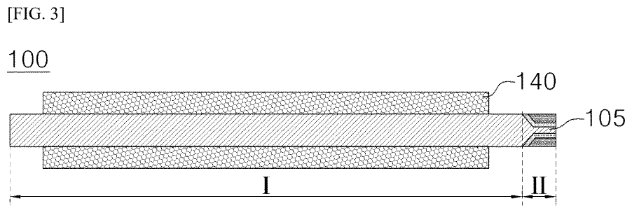

FIG. 3 is a schematic cross-sectional view illustrating a cathode for a lithium secondary battery according to exemplary embodiments.

Referring to FIG. 3, the cathode 100 may include the cathode current collector 105 and the cathode active material layer 140 formed by applying a cathode active material to the cathode current collector 105. The cathode active material layer 140 may be formed on at least a portion of the active region of the cathode current collector 105.

The cathode active material layer 140 may be prepared by coating the active region of the cathode current collector 105 with a cathode slurry, followed by compression and drying the same. The cathode slurry may be prepared by mixing and stirring the cathode active material with a binder, a conductive material and/or a dispersant in a solvent.

According to exemplary embodiments, the cathode active material may include a compound capable of reversibly intercalating and deintercalating lithium ions. The cathode active material may include lithium-transition metal composite oxide particles. For example, the lithium-transition metal composite oxide particles include nickel (Ni), and may further include at least one of cobalt (Co) and manganese (Mn).

For example, the lithium-transition metal composite oxide particles may be represented by Formula 1 below.

LiₓNi_{1-y}M_{y}O_{2+z} [Formula 1]

In Formula 1, x may be in a range of 0.9≤x≤1.1, y may be in a range of 0≤y≤0.7,

and z may be in a range of −0.1≤z≤0.1. M may represent one or more elements selected from Na, Mg, Ca, Y, Ti, Zr, Hf, V, Nb, Ta, Cr, Mo, W, Mn, Co, Fe, Cu, Ag, Zn, B, Al, Ga, C, Si or Sn.

The cathode binder may include, for example, an organic binder such as vinylidene fluoride-hexafluoropropylene copolymer (PVDF-co-HFP), polyvinylidene fluoride (PVDF), polyacrylonitrile, polymethyl methacrylate, etc., or aqueous binder such as styrene-butadiene rubber (SBR), and may be used together with a thickener such as carboxymethyl cellulose (CMC).

For example, a PVDF-based binder may be used as the cathode binder. In this case, an amount of the binder for forming the cathode active material layer may be reduced and an amount of the cathode active material may be relatively increased, thereby improving the output and capacity of the secondary battery.

The conductive material may be included to facilitate electron transfer between the active material particles. For example, the conductive material may include a carbon-based conductive material such as graphite, carbon black, graphene, or carbon nanotubes and/or a metal-based conductive material including tin, tin oxide, titanium oxide, or a perovskite material such as LaSrCoO₃, and LaSrMnO₃, etc.

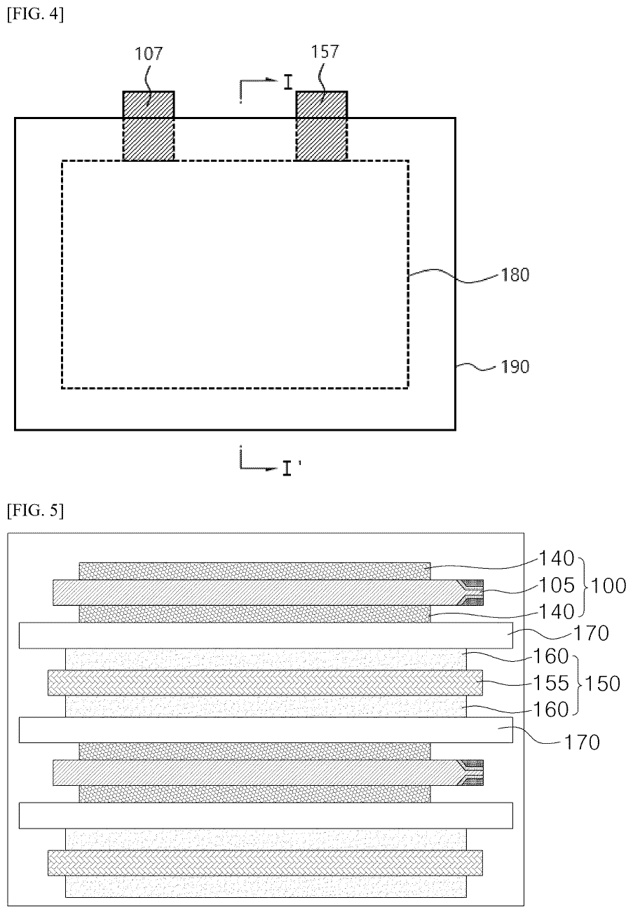

FIGS. 4 and 5 are a schematic plan view and a cross-sectional view illustrating a lithium secondary battery according to exemplary embodiments, respectively. FIG. 7 is a cross-sectional view taken on line I-I′ in FIG. 6 in a thickness direction of the battery.

Referring to FIGS. 4 and 5, the lithium secondary battery may include a cathode 100 including the above-described cathode current collector 105 and an anode 150 disposed to face the cathode.

According to exemplary embodiments, the anode 150 may include an anode current collector 155 and an anode active material layer 160 formed by coating the anode current collector 155 with an anode active material.

The anode active material usable in the present invention may include any material known in the related art, so long as it can intercalate and deintercalate lithium ions, without particular limitation thereof. For example, carbon-based materials such as crystalline carbon, amorphous carbon, carbon composite, carbon fiber, etc.; a lithium alloy; a silicon (Si) compound or tin, etc. may be used. Examples of the amorphous carbon may include hard carbon, cokes, mesocarbon microbead (MCMB) calcined at 1600° C. or lower, mesophase pitch-based carbon fiber (MPCF) or the like.

Examples of the crystalline carbon may include graphite-based carbon such as natural graphite, graphite cokes, graphite MCMB, graphite MPCF or the like. Other elements included in the lithium alloy may include, for example, aluminum, zinc, bismuth, cadmium, antimony, silicon, lead, tin, gallium or indium, etc.

The silicon-based active material may include SiOₓ (0<x<2) or SiOₓ (0<x<2) containing a lithium compound. The SiOₓ containing the Li compound may be SiOₓ including lithium silicate. The lithium silicate may be present in at least a portion of SiOₓ (0<x<2) particles, for example, may be present inside and/or on the surface of the SiOₓ (0<x<2) particles. In one embodiment, the lithium silicate may include Li₂SiO₃, Li₂Si₂O₅, Li₄SiO₄, Li₄Si₃O₈, etc.

The silicon-based active material may also include a silicon-carbon composite compound such as silicon carbide (SIC).

The anode current collector 155 may include, for example, gold, stainless steel, nickel, aluminum, titanium, copper or an alloy thereof, and in one embodiment, the anode current collector 155 may include copper or a copper alloy.

For example, a slurry may be prepared by mixing the anode active material with the above-described binder, conductive material, thickener, and the like in a solvent, and stirring the mixture. The slurry may be applied to at least one surface of the anode current collector 155, followed by compression and drying the same to prepare the anode 150 including the anode active material layer 160.

As the binder and the conductive material, materials which are substantially the same as or similar to the above-described materials may be used. In some embodiments, a binder for forming an anode may include, for example, an aqueous binder such as styrene-butadiene rubber (SBR) to ensure compatibility with a carbon-based active material, and may be used together with a thickener such as carboxymethyl cellulose (CMC).

In some embodiments, a separation membrane 170 may be interposed between the cathode 100 and the anode 150. The separation membrane 170 may include a porous polymer film made of a polyolefin polymer such as ethylene homopolymer, propylene homopolymer, ethylene/butene copolymer, ethylene/hexene copolymer, ethylene/methacrylate copolymer. The separation membrane 170 may include a nonwoven fabric made of glass fibers having a high melting point, polyethylene terephthalate fibers, etc.

In some embodiments, the anode 150 may have an area (e.g., a contact area with the separation membrane 170) and/or volume larger than those/that of the cathode 100. Thereby, lithium ions generated from the cathode 100 may smoothly migrate to the anode 150 without being precipitated during the process, for example. Accordingly, the effect of simultaneous improvement of output and stability through combination with the above-described composite hydroxide particles or cathode active material may be more easily implemented.

According to exemplary embodiments, an electrode cell is defined by the cathode 100, the anode 150 and the separation membrane 170, and a plurality of electrode cells may be stacked to form an electrode assembly 180.

The electrode assembly 180 may be housed together with an electrolyte in an

outer case 190 to define a lithium secondary battery. According to exemplary embodiments, a non-aqueous electrolyte may be used as the electrolyte.

The non-aqueous electrolyte may include a lithium salt of an electrolyte and an organic solvent, the lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₆PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF³(CF₂)₇SO₃⁻, CF₃CO₂, CH₃CO₂⁻, SCN⁻ and (CF₃CF₂SO₂)₂N⁻, etc. may be exemplified.

As the organic solvent, for example, propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethyl sulfoxide, acetonitrile, dimethoxyethane, diethoxyethane, vinylene carbonate, sulfolane, γ-butyrolactone, propylene sulfite, tetrahydrofuran, and the like may be used. These compounds may be used alone or in combination of two or more thereof.

As shown in FIG. 4, electrode tabs (a cathode tab and an anode tab) may protrude from the cathode current collector 105 and the anode current collector 155, respectively, which belong to each electrode cell, and may extend to one side of the case 190. The cathode current collector 105 and the anode current collector 155 may include the bonding region and the active region, respectively, and the electrode tabs (the cathode tab and the anode tab) may be bonded to the bonding portions and may protrude. The electrode tabs may be bonded to the electrode tab bonding regions. The electrode tabs may be fused together with the one side of the case 190 to form electrode leads (a cathode lead 107 and an anode lead 157) extending or exposed to the outside of the case 190.

The lithium secondary battery may be manufactured, for example, in a cylindrical shape using a can, a prismatic shape, a pouch-type shape or a coin shape.

Hereinafter, embodiments of the present disclosure will be further described with reference to specific experimental examples. However, the following examples and comparative examples included in the experimental examples are only given for illustrating the present disclosure and those skilled in the art will obviously understand that various alterations and modifications are possible within the scope and spirit of the present disclosure. Such alterations and modifications are duly included in the appended claims.

### EXAMPLES AND COMPARATIVE EXAMPLES

### Example 1

### 1) Preparation of Cathode Current Collector

A copper foil was bonded to both surfaces of a second region of an aluminum foil using a roll-to-roll process. A metal foil, formed by bonding an aluminum foil and a copper foil, was hot rolled at 600°° C. to form a preliminary aluminum-copper alloy layer through recrystallization of aluminum and copper. An aluminum-copper alloy layer was formed by heat treating the preliminary aluminum-copper alloy layer at 450° C. to achieve homogenization. Then, first cold rolling, first annealing, second cold rolling and second annealing were performed. Thereafter, the length of the non-coated part including the second region was notched to be the same as the length of the end of the cathode tab, thereby preparing a cathode current collector including the bonding region.

The aluminum-copper alloy layer was formed in the order of an Al₂Cu layer, an AlCu layer and an AlCu₂ layer from the aluminum layer at the center.

### 2) Preparation of Cathode

LiNi_{0.6}Co_{0.2}Mn_{0.2}O₂ as a cathode active material, carbon black as a cathode conductive material, and polyvinylidene fluoride (PVDF) as a cathode binder were mixed in a weight ratio of 95:3:2 to prepare a cathode slurry, and then the cathode slurry was applied to a region of the cathode current collector except for a cathode tab bonding portion, followed by drying and pressing the same, to form a cathode active material layer.

Thereafter, the cathode current collector and the cathode tab were bonded through the bonding region to prepare a cathode.

The cathode tab was formed of copper.

### 3) Preparation of Anode

An anode active material obtained by mixing artificial graphite and natural graphite in a weight ratio of 7:3; styrene-butadiene rubber; and carboxymethyl cellulose were dispersed in distilled water in a weight ratio of 97:1:2 to prepare an anode slurry.

The anode slurry was applied to a region of a copper foil having a protrusion part except for the protrusion part, followed by drying and pressing the same, to prepare an anode. Thereafter, the protrusion was connected to an anode tab to prepare an anode.

The anode tab was formed of copper.

### 4) Manufacture of Secondary Battery Cell

A polyethylene separation membrane (thickness: 20 μm) was interposed between

the cathode and the anode to form a unit electrode assembly. An electrode assembly was formed by stacking the unit electrode assemblies to have a capacity of 80 Ah. A cathode lead and an anode lead were respectively welded and connected to the cathode tab and the anode tab.

The cathode lead and the anode lead were formed of copper and had a thickness of 0.3 mm.

A 1 M LiPF₆ solution (a mixed solvent of EC and EMC in a volume ratio of 30:70) was prepared, and then 1 wt % of fluoroethylene carbonate (FEC), 0.3 wt % of vinylethylene carbonate (VC), 1 wt % of lithium difluorophosphate (LiPO2F2), 0.5 wt % of 1,3-propane sultone (PS), and 0.5 wt % of prop-1-ene-1,3-sultone (PRS) were added thereto in the above-described contents based on 100 wt % of the total electrolyte, to prepare an electrolyte.

The electrode assembly was housed in a pouch (case) so that some regions of the cathode lead and the anode lead were exposed to the outside of the pouch, followed by sealing three sides of the pouch except for a side of an electrolyte injection part.

The electrolyte was injected into the pouch, and the side of the electrolyte injection part was sealed to manufacture a lithium secondary battery.

### 5) Manufacture of Secondary Battery Module

The leads of the secondary battery were connected to a bus bar to interconnect the lithium secondary batteries and to manufacture a lithium secondary battery module.

The bus bar was formed of copper, and 12 lithium secondary batteries were connected to form one pack of the secondary battery module.

### Example 2

A lithium secondary battery and a lithium secondary battery module were

manufactured in the same manner as Example 1, except that the cathode tab and the cathode lead were formed of aluminum and the thickness of the cathode lead was 0.4 mm.

### Comparative Example 1

A lithium secondary battery and a lithium secondary battery module were manufactured in the same manner as Example 1, except that the cathode current collector was formed of aluminum foil, the cathode tab and the cathode lead were formed of aluminum, and the thickness of the cathode lead was 0.4 mm.

### EXPERIMENTAL EXAMPLE

### (1) Measurement of Resistance At Welded Portion Between Electrode Current Collector and Electrode Tab

A resistance meter was connected to both ends of the cathode current collector and the cathode tab, and a microcurrent was applied to measure the resistance at the welded portion.

Also, the resistance meter was connected to both ends of the anode current collector and the anode tab, and a microcurrent was applied to measure the resistance at the welded portion.

### (2) Measurement of Resistance Of Secondary Battery Cell

At the point where the state of charge (SOC) of the secondary batteries according to the examples and comparative examples was set to 50%, a current of 1C was applied for 10 seconds, and the cell resistance was calculated through a change in voltage.

### (3) Measurement of Resistance of Secondary Battery Module

At the point where the state of charge (SOC) of the secondary battery modules according to the examples and comparative examples was set to 50%, a current of 1C was applied for 10 seconds, and the module resistance was calculated through a change in voltage.

The evaluation results are shown in Table 1 below.

TABLE 1

| | Resistance | Resistance | Resistance | Resistance |
|---|---|---|---|---|
| | at cathode | at anode | of secondary | of secondary |
| | welded | welded | battery cell | battery module |
| | portion (mΩ) | portion (mΩ) | (mΩ) | (mΩ) |
| Example 1 | 0.015 | 0.017 | 1.095 | 13.53 |
| Example 2 | 0.025 | 0.017 | 1.105 | 14.06 |
| Comparative | 0.02 | 0.017 | 1.1 | 13.86 |
| Example 1 | | | | |

Referring to Table 1, in Example 1, where both the surface of the bonding region of the cathode current collector and the cathode tab were formed of copper, all the resistance at the cathode tab welded portion, the resistance of the secondary battery cell, and the resistance of the secondary battery module were reduced. In Example 2, where the surface of the bonding region of the cathode current collector was formed of copper, but the cathode tab was formed of aluminum, all the resistance at the cathode tab welded portion, the resistance of the secondary battery cell, and the resistance of the secondary battery module were slightly increased.

In Comparative Example 1, where both the bonding region of the cathode current collector and the cathode tab were formed of aluminum, all the resistance at the cathode tab welded portion, the resistance of the secondary battery cell, and the resistance of the secondary battery module were slightly increased.

1. A cathode current collector for a lithium secondary battery comprising:
a first metal layer which comprises a first region and a second region having a thickness smaller than that of the first region; and
a second metal layer which is disposed on the second region of the first metal layer and has a different composition from that of the first metal layer.

2. The cathode current collector for a lithium secondary battery according to claim 1, wherein the first metal layer is a single layer containing aluminum.

3. The cathode current collector for a lithium secondary battery according to claim 2, wherein the second metal layer comprises copper.

4. The cathode current collector for a lithium secondary battery according to claim 3, wherein the second metal layer comprises an aluminum-copper alloy layer disposed on the second region of the first metal layer, and a copper layer disposed on the aluminum-copper alloy layer.

5. The cathode current collector for a lithium secondary battery according to claim 4, wherein the aluminum-copper alloy layer comprises at least one of Al₂Cu, AlCu and AlCu₂.

6. The cathode current collector for a lithium secondary battery according to claim 1, wherein the second metal layer is not formed on the first region of the first metal layer.

7. The cathode current collector for a lithium secondary battery according to claim 1, wherein the cathode current collector has a constant thickness overall.

8. The cathode current collector for a lithium secondary battery according to claim 1,
wherein the second region comprises a distal part having a constant thickness, and an inclined part extending between the first region and the distal part,
wherein the thickness of the inclined part gradually decreases toward the distal part from the first region.

9. The cathode current collector for a lithium secondary battery according to claim 1, wherein the second metal layer is formed on both surfaces of the second region of the first metal layer.

10. A lithium secondary battery comprising:
a cathode which comprises the cathode current collector according to claim 1, and
a cathode active material layer disposed on the cathode current collector; and
an anode disposed to face the cathode.

11. The lithium secondary battery according to claim 10, wherein the cathode current collector comprises an active region corresponding to the first region, and a bonding region corresponding to the second region, and
the cathode active material layer is disposed on at least a portion of the active region.

12. A method of preparing a cathode current collector for a lithium secondary battery comprising:
forming a preliminary current collector by bonding a second metal foil having a different composition from that of the first metal foil on a partial region of at least one surface of the first metal foil; and
heat treating the preliminary current collector,
wherein the preliminary current collector comprises a first preliminary metal layer which comprises an active part and a non-coated part having a thickness smaller than that of the active part, and a second preliminary metal layer formed on the non-coated part.

13. The method of preparing a cathode current collector for a lithium secondary battery according to claim 12, wherein the step of forming a preliminary current collector comprises:
pressing a partial region of the first metal foil to form a groove; and
bonding the second metal foil to the groove.

14. The method of preparing a cathode current collector for a lithium secondary battery according to claim 12, wherein the step of forming a preliminary current collector comprises:
placing the second metal foil on a partial region of the first metal foil; and
rolling and bonding the first metal foil and the second metal foil.

15. The method of preparing a cathode current collector for a lithium secondary battery according to claim 12, wherein the preliminary current collector further comprises a preliminary alloy layer formed between the first preliminary metal layer and the second preliminary metal layer.

16. The method of preparing a cathode current collector for a lithium secondary battery according to claim 15, wherein the step of forming a preliminary current collector further comprises:
hot rolling the first metal foil to which the second metal foil is bonded.

17. The method of preparing a cathode current collector for a lithium secondary battery according to claim 12, wherein the step of heat treating the preliminary current collector comprises:
cold rolling the preliminary current collector; and annealing the cold rolled preliminary current collector.

18. The method of preparing a cathode current collector for a lithium secondary battery according to claim 12, wherein the second metal foil is bonded to a central portion in a width direction of the first metal foil along a longitudinal direction, and
further comprising, after the step of heat treating the preliminary current collector, slitting the central portion in the width direction of the heat treated preliminary current collector along the longitudinal direction.
